(19) United States
(12) Patent Application Publication
(10) Pub. No.: US 2012/0092250 A1
(43) Pub. Date: Apr. 19, 2012

(54) FINGER-OPERATED INPUT DEVICE

(75) Inventors: Noam Hadas, Tel Aviv (IL); Vladimir Muzykovski, Beit Shemesh (IL); Ailon Tamir, Kiryat Arba (IL)

(73) Assignee: MICROPOINTING LTD., Kiryat Arba (IL)

(21) Appl. No.: 13/377,721

(22) PCT Filed: Jun. 14, 2010
(86) PCT No.: PCT/IL10/00469

§ 371 Date: Dec. 12, 2011

Related U.S. Application Data
(60) Provisional application No. 61/186,848, filed on Jun. 14, 2009.

(51) Int. Cl. G09G 5/00

(52) U.S. Cl. 345/156

(57) ABSTRACT

The finger-operated input device connectable to a digital device is disclosed. The aforesaid input device comprises (a) a sensing pad being responsive to displacement of the finger substantially parallel to the pad in a reach range thereof and transmitting electrical signals in response thereto; and (b) an analyzing unit arranged to receive said electrical signals and calculate a data defining trajectory of the finger and transmit the data to the digital device; The sensing pad comprises at least three sensors perceptive to motion of the finger relative to the sensors.

### FIELD OF THE INVENTION

The present invention relates to an input device, and, more specifically, to an input device operated by a user's finger.

### BACKGROUND OF THE INVENTION

Personal computer systems generally include desktop systems and laptop systems that can operate alone or in network applications. Desktop computer systems typically include a computer processor and a separate display positioned on a desktop, table or other type of support structure. A primary input device, such as a keyboard, is coupled to the processor to allow a user to transmit alphanumeric commands to the processor. Conventional desktop computer systems also generally include at least one secondary input device, such as a mouse, that has a motion detector and one or more input buttons to control a pointer or cursor on the display. For example, the motion detector can be a roller-ball mechanism and the input buttons can include left and right input buttons to click selected areas of the display. In many conventional desktop systems, the roller-ball mechanism is operated on a mouse pad that has a surface area of approximately 40-80 in².

One drawback with a typical mouse is the inconvenience of using the aforesaid mouse in many desktop applications. More specifically, one problem is that crowded desktops or tabletops may not have sufficient space for operating a full-sized mouse configured to fit the palm of a user because mouse pads occupy a significant amount of surface area. Another problem is that many computer users need to reach away from the keyboard to grasp the mouse. For example, when the keyboard is supported by a pull-out tray that slides underneath the desktop, many computer users need to stretch to reach a mouse supported by the desktop in front of the keyboard. Such stretching for a mouse is not only tiresome, but is also interrupts the operation of the computer. Thus, it may be inconvenient or even uncomfortable to operate conventional full-sized secondary input devices in desktop applications.

Laptop computer systems are generally portable devices that operate from either external or portable power sources. Conventional laptop computer systems typically have a base assembly pivotally connected to a display assembly. The base assembly typically includes the primary input device (e.g., keyboard), and the display assembly typically includes a liquid crystal display (LCD) or another type of display. To access the keyboard and the display, a user positions the base assembly on a surface (e.g., the user's lap or a fixed surface) and pivots the display assembly away from the base assembly. To stow and easily transport the computer after use, the user secures the display assembly to the base assembly in a closed configuration.

A smartphone is a mobile phone that offers more advanced computing ability and connectivity than a basic ‘feature phone’. While some feature phones are able to run simple applications based on generic platforms such as Java ME or BREW, a smartphone allows the user to install and run much more advanced applications based on a specific platform. Smartphones run complete operating system software providing a platform for application developers.

A personal digital assistant (PDA), also known as a palmtop computer, is a mobile device which functions as a personal information manager and has the ability to connect to the internet. The PDA has an electronic visual display enabling it to include a web browser, but some newer models also have audio capabilities, enabling them to be used as mobile phones or portable media players. Many PDAs can access the internet, intranets or extranets via Wi-Fi, or Wireless Wide Area Networks (WWANs).

It should be that all mobile digital devices need a miniature navigating input device.

U.S. Pat. No. 6,366,274 ('274) discloses input devices for controlling a pointer or other visual indicator on a display of a computer system. In one embodiment, an input device includes a body configured to face a support structure, a projecting member extending between the body and the support structure, and a position sensor operatively connected to the projecting member. The body may be a housing including a first section or bottom section configured to move over the support structure, and a second section or top section facing generally away from the support structure. The second section can have a contoured surface extending over the support structure such that the contoured surface is configured to engage a palm of a hand of a user. The body, for example, may be a full-sized mouse housing configured to be gripped by a user. The projecting member can have a first portion connected to either the body or the support structure, and the projecting member can have a second portion projecting from the first portion toward the other of the body or the support structure. The projecting member can be a rod having a first end pivotally connected to the body and a second end engaged with the support structure such that the second end is inhibited from moving with respect to the support structure. In this embodiment, the position sensor is attached to the body. As the body moves over the support structure, the projecting member moves with respect to the position sensor corresponding to the relative movement between the body and the support structure. The position sensor accordingly detects the relative displacement and velocity of the projecting member, and the position sensor sends signals to the computer to control the pointer on the display corresponding to the relative movement between the body and the support structure.

It is a long felt need to provide and disclose miniature computer and communication means. The input devices such as a mouse, a rollerball, a touchpad, or a joystick have quite large irreducible finite sizes and are inapplicable to miniature computer and communication for want of space. Providing miniature input devices not requiring moving parts is thus also an unmet long-felt need.

### SUMMARY OF THE INVENTION

It is hence one object of the invention to disclose a finger-operated input device connectable to a digital device. The aforesaid input device comprises (a) a sensing pad being responsive to displacement of the finger substantially parallel to the pad in a reach range thereof and transmitting electrical signals in response thereto; and (b) an analyzing unit arranged to receive the electrical signals and calculate data defining trajectory of the finger and transmit the data to the digital device.

It is a core purpose of the invention to provide the sensing pad comprising at least three sensors perceptive to motion of the finger relative to the sensors.

A another object of this disclosure is to disclose the abovementioned invention wherein a distance between the sensors is smaller than a distance between any two adjacent ridges of user's finger; the distance between the sensors is less than about 0.5 mm, preferably less 0.1 mm.

A further object of this disclosure is to disclose the abovementioned invention wherein the pad is arranged to be perceptively different from the environment.

A further object of this disclosure is to disclose the abovementioned invention wherein the difference in perception is selected from the group consisting of color, material, texture, temperature of the sensing pad relative to the environment and any combination thereof. Difference in perception can be also achieved by a difference in relief between the sensing pad and environment.

A further object of this disclosure is to disclose the abovementioned invention wherein the analyzing unit is arranged to receive and differentially analyze a sequence of the timely framed signals in a cyclic manner.

A further object of this disclosure is a method of inputting commands by a user's finger into a digital device. The aforesaid method comprises the steps of: (a) providing a finger-operated navigating device; (b) displacing a user's finger in parallel to the sensing pad; (c) detecting the finger displacing; (d) cyclically picking up electrical signals generated by the sensors, (e) differentially analyzing obtained signals; (f) calculating a trajectory of the finger; and (g) generating the commands corresponding to the calculated trajectory.

The step of detecting the finger displacing is performed by at least three sensors embedded into a sensing pad. The sensors are perceptive to motion of finger relative to the sensors.

A further object of this disclosure is to disclose the abovementioned invention wherein the step of displacing the finger is performed in parallel to the pad which is arranged to be perceptively different from the housing.

A further object of this disclosure is to disclose the abovementioned invention wherein the step of displacing the finger is performed in mechanical contact with the sensing pad.

A further object of this disclosure is to disclose the abovementioned invention wherein the step of displacing the finger is performed in a non-contact manner with the sensing pad.

A further object of this disclosure is to disclose the abovementioned invention wherein the step of cyclically picking up the electrical signals is performed in a spatial domain mode.

A further object of this disclosure is to disclose the abovementioned invention wherein the step of cyclically picking up the electrical signals is performed in a time domain mode.

A further object of this disclosure is to disclose the abovementioned invention wherein a picking frequency is higher than 120 frames per second.

It is hence one object of the invention to disclose a finger-operated input device for controlling a pointer on a display of a digital device. The aforesaid input device comprises a support structure, at least three projecting members, force sensors singly attached to each the projecting member; and an analyzing unit. The projecting members have first and second terminals so that they are substantially adjacently mechanically secured at substantially normal orientation to the support structure by means of the first terminal.

It is a core purpose of the invention to provide the sensors adapted to provide the analyzing unit with signals corresponding to forces longitudinally applied to the projecting members by the user's finger moving substantially transversely to the projecting members and contacting the second terminal portions thereof. The analyzing unit is adapted for calculating the user's finger transverse movement and transmitting calculation results to the digital device.

Another object of the invention is to disclose a cross sectional dimension of an extremity of the second terminal portion of each projecting member approximately in the order of the distance between any two adjacent ridges of user's finger. The sectional dimension of the second extremity is in a range of about 0.1 to about 2.0 mm, preferably in a range of about 0.2 to about 0.5 mm.

A further object of the invention is to disclose the analyzing unit adapted to be activated in response to the sensor signal larger than a predetermined value.

A further object of the invention is to disclose the analyzing unit adapted for changeably scaling data transmitted to the digital device.

A further object of the invention is to disclose at least one projecting member provided with a thermal sensor adapted to activate the input device in response to contacting the projecting member to an object of a temperature substantially higher than ambient temperature and equal to a temperature of the user's finger for preventing false activation.

A further object of the invention is to disclose the input device further comprising a band filter having a bandpass substantially equal to a bandpass of the signal corresponding to finger movement. The filter is adapted to filter noise of the signal transmitted by the force sensors to the analyzing unit.

A further object of the invention is to disclose a finger-operated input device for controlling a pointer on a display of a digital device. The aforementioned the input device comprises a support plate-like structure having first and second sides and a regularly disposed matrix of passages between the sides, a plurality of sensors individually mechanically secured to the passages from the first side, and an analyzing unit.

It is a core purpose of the invention to provide pneumatic sensors adapted to transmit to the analyzing unit a signal corresponding to a pneumatic impulse provided by the user's finger moving substantially transversely and contacting the second side. The analyzing unit is adapted for calculating the finger's transverse movement and transmitting calculation results to the digital device.

A further object of the invention is to disclose sensors chosen from the group of sensors providing electrical signals in response to pneumatic, elastic, optical and capacitive effects.

A further object of the invention is to disclose the analyzing unit adapted to be activated in response to the sensor signal larger than a predetermined value.

A further object of the invention is to disclose the analyzing unit adapted for changing the scale of the data which is transmitted to the digital device.

A further object of the invention is to disclose the support structure provided with a thermal sensor adapted to activate the input device in response to contacting an object of a temperature substantially equal to the temperature of the finger in order to prevent false activation

A further object of the invention is to disclose the input device further comprising a band filter having a bandpass substantially equal to a bandpass of the signal corresponding to movement of the finger. The filter is adapted to filter noise the signal transmitted by the force sensors to the analyzing unit.

A further object of the invention is to disclose a sensor adapted to detect finger surface features, chosen from the group consisting of a microelectomechanical system, a strain gauge, an optical displacement sensor, an optical reflective sensor, a capacitive sensor, and any combination thereof. Any other sensor adapted to measure the distance between the skin and the support structure or the local force applied by the finger at a specific point at the support structure are in the scope of the current invention.

A further object of the invention is to disclose a finger-operated input device for controlling a digital device comprising: (a) a support structure; (b) at least three projecting members having first and second terminal; the members are mechanically secured substantially adjacent to each other, at a substantially normal orientation to the support structure by means of the first; (c) capacitive sensors, at least one force sensor attached to each the projecting member; the capacitive sensors are adapted for measuring a distance to finger skin; and (d) an analyzing unit.

It is a core purpose of the invention to provide the sensor adapted to provide the analyzing unit with signals corresponding to forces longitudinally applied to the projecting members by the user's finger movement substantially transverse to the projecting members. The analyzing unit is adapted for calculating the user's finger transverse moving and transmitting calculation results to the digital device.

A further object of the invention is to disclose the analyzing unit adapted to recognize at least two levels of the user's control action. The levels comprise a regular level and at least one level higher in comparison with the regular level. The control action of the higher level is adapted for providing an independent input data channel.

A further object of the invention is to disclose a method of controlling a pointer at a screen of a digital device. The method comprises the steps of (a) providing a finger-operated input device comprising a support structure, at least three projecting members having first and second terminal, force sensors singly attached to each the projecting member, and an analyzing unit, (b) bringing the user's finger into proximity with the extremities of the projecting member, (c) transversely moving the finger so as to contact the projecting members, (d) transmitting signals corresponding to forces applied to the projecting members to the analyzing unit, (e) analyzing the signals, (f) transmitting digital data corresponding to a transversal displacement of the user's finger.

A further object of the invention is to disclose the step of analyzing the signals activated in response to the sensor signal larger than a predetermined value.

A further object of the invention is to disclose the step of analyzing further comprising changeably scaling data transmitted to the digital device.

A further object of the invention is to disclose the step of analyzing activated in response to contacting the projecting member to an object of a temperature substantially equal to the temperature of the user's finger.

A further object of the invention is to disclose the step of transmitting digital data further comprising filtering the signals by a band filter having a bandpass substantially equal to a bandpass of the signal corresponding to the movement of the finger at reasonable speeds.

A further object of the invention is to disclose a method of controlling the operation of a digital device. The method comprises the steps of (a) providing a finger-operated input device comprising a support plate-like structure having first and second sides and a regularly disposed matrix of passages between the support structure sides, a plurality of sensors individually mechanically secured to the passages from the first side, and an analyzing unit; (b) bringing the user's finger into proximity with the supporting plate; (c) transversely moving the user's finger so as to contact the projecting members; (d) transmitting signals corresponding to forces applied to the projecting members to the analyzing unit; (e) analyzing the signals; (f) transmitting digital data corresponding to a transversal displacement of the user's finger.

A further object of the invention is to disclose the signals transmitted by the sensors chosen from the group of sensors providing electrical signals in response to pneumatic, elastic, and capacitive effects.

A further object of the invention is to disclose the step of analyzing the signals that is activated in response to the sensor signal larger than a predetermined value.

A further object of the invention is to disclose the step of analyzing further comprising changeably scaling the data transmitted to the digital device.

A further object of the invention is to disclose the analyzing step that is initiated in response to contacting an object of a temperature substantially equal to the temperature of the user's finger to the second side of the support structure.

A further object of the invention is to disclose the step of transmitting digital data further comprising filtering the sensor signals by a band filter having a bandpass substantially equal to a bandpass of the sensor signal corresponding to the finger movement.

### BRIEF DESCRIPTION OF THE DRAWINGS

In order to understand the invention and to see how it may be implemented in practice, a plurality of embodiments to be adopted is now described, by way of non-limiting example only, with reference to the accompanying drawings, in which

FIG. 1 is a graph of the coordinate dependence of height profile h(x) of a moving object;

FIG. 2 is a graph of the time dependence of height profile h(t) of a moving object;

FIG. 3 is a schematic view of the sensor arrangement;

FIG. 4 is a schematic diagram of the input device;

FIG. 5 is a conceptual view of the input device operated by means moving the user's finger in a path and contacting the projecting members with the finger ridges;

FIG. 6 is conceptual view of the finger-operated input device enclosed in the housing;

FIG. 7 is a geometric diagram of the user's finger path;

FIG. 8 is a graph of the signals corresponding to the forces applied to the projecting members;

FIG. 9 is a conceptual view of the input device operated by means of moving the users finger such that finger induced pneumatic impulses are transmitted to the support plate;

FIG. 10 is a flowchart of the method of using the finger-operated input device based on finger skin relief;

FIG. 11 is a flowchart of the method of using the finger-operated input device based on pneumatic impulses induced by the user's fingers;

FIG. 12 is a photograph of the finger ridges;

FIG. 13 is a graph of simulated sensor readings for motion in the X-direction;

FIG. 14 is a graph of simulated sensor readings for motion in the Y-direction;

FIG. 15 is a graph of simulated velocity profile for motion in the X-direction;

FIG. 16 is a graph of simulated velocity profile for motion in the Y-direction;

FIG. 17 is a graph of simulated trajectory profile for motion in the X-direction;

FIG. 18 is a graph of simulated trajectory profile for motion in the Y-direction; and

FIG. 19 is a graph of simulated trajectories obtained by the differential and reference algorithms.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a finger-operated input device connectable to a digital device and a method of using the same.

The term “digital device” for the purposes of the current invention hereinafter refers to any kind of the devices having a display and a pointer thereupon controlled by any input device. It is acknowledged herein that preferred embodiments of the invention are provided by example, and that the device is an input tool for any type of control application for an electronic or electro mechanical device, such as the control of a pointer on a PC (personal computer), laptop computer, palm pilot, mobile device (such as a mobile telephone interface or other mobile display). Some embodiments of the invention are provided for control of volume and station selection in a radio receiver, radio transmitter, zoom control in a camera, various controls in a video recording device, robot, surgical robot steering of a motor car and any other motorized vehicle.

The differential approach allows calculating the finger motion over the sensor device using a total derivative equation of the measured signals. This equation binds temporal (t) and spatial (X and Y) derivatives of measured signals with the finger velocity vector. The unknown velocities calculation in X and Y directions requires a minimum number of measurements. However, in practice, measurement noise and other factors influence on the quality of the measured signals and their validity. Therefore, in order to overcome these measurement issues, a greater number of measurements/signal-samples are required. These measurements/signal-samples are used to filter/smooth the calculation results by means of statistical calculations.

Increasing the number of sampled measurements can be done in the following ways:

(a) increase in the number of sensors and perform the measurements at two consecutive moments. This mode is defined as a Spatial Domain mode.

(b) use at least three sensors and increase the number of consecutive measurements. This is a Time Domain mode.

The Time Domain mode is used for obtaining a finger velocity vector. PTS uses frame rates higher than 120 fps in order to enable efficient motion detection for medium and rapid movements of the finger too.

The Differential Method of Motion Detection (DMMD) is an alternative method that allows extraction of motion velocity X and Y coordinates from spatial and time dependent derivatives of measured signals. The method's advantage is in its relative simple and fast calculations that do not require a search of optimal correlation between images or signals. The DMMD method can be implemented as Time or Spatial domain algorithms (see bellow).

A time dependent image of moving object I(x, y, t) can be expressed as function of spatial coordinates x and y, where each spatial coordinate depends on time:

I(x,y,t)=I(x(t),y(t)). (1)

If each argument of function depends on some parameter t, the total function dependence on this parameter can be expressed as:

$$\frac{d I ( x ( t ) , y ( t ) )}{d t} = \frac{\partial I ( x ( t ) , y ( t ) )}{\partial x} \cdot \frac{d x}{d t} + \frac{\partial I ( x ( t ) , y ( t ) )}{\partial y} \cdot \frac{d y}{d t} . \qquad ( 2 )$$

In our case of moving object:

$$\begin{matrix}\frac{d x}{d t} = {v}_{x} and & ( 3 ) \\ \frac{d y}{d t} = {v}_{y} , & ( 4 )\end{matrix}$$

where vₓ and vₓ are x and y coordinates of object velocity.

Therefore, the equation (2) can be expressed as

$$\frac{d I ( x ( t ) , y ( t ) )}{d t} = \frac{\partial I ( x ( t ) , y ( t ) )}{\partial x} \cdot {v}_{x} + \frac{\partial I ( x ( t ) , y ( t ) )}{\partial y} \cdot {v}_{y} . \qquad ( 5 )$$

For small Δx, Δy and Δt, the expression (5) can be estimated in terms of differences between closed signals:

$$\frac{I ( x , y , t + Δ t ) - I ( x , y , t )}{Δ t} \approx \frac{I ( x + Δ x , y , t ) - I ( x , y , t )}{Δ x} \cdot {v}_{x} + \frac{I ( x , y + Δ y , t ) - I ( x , y , t )}{Δ y} \cdot {v}_{y} \qquad ( 6 )$$

For better understanding let us illustrate the DMMD method for case of 1D.

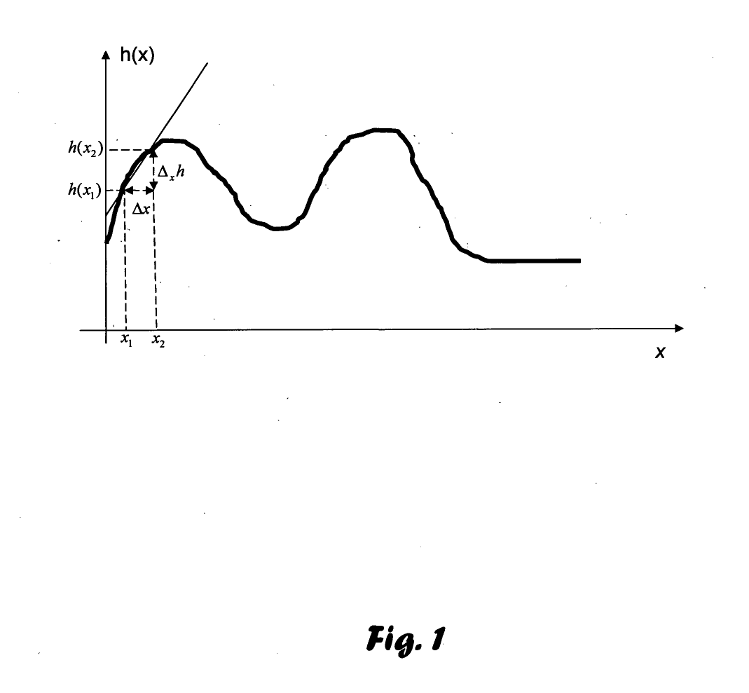

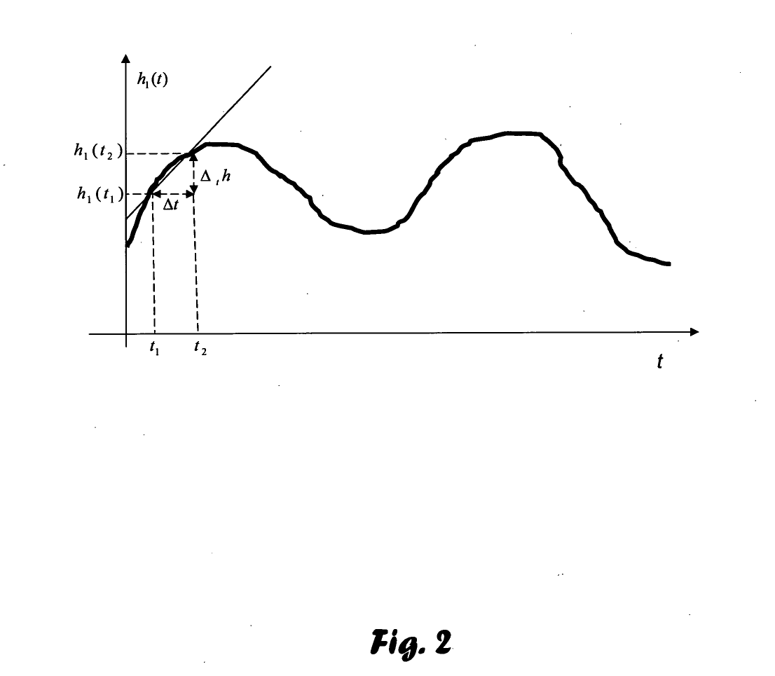

Reference is now made to FIGS. 1 and 2, which illustrate one-dimensional consideration. A height profile h(x) of a moving object (a ridged user's finger) is represented as a function depending on x coordinate (see FIG. 2). The measurement system includes two sensors. Measurements of height h are performed in two closed points x₁ and x₂ as shown on FIG. 2.

At each time the approximate value of spatial derivative can be calculated using the reading s from both sensors received simultaneously:

$$\frac{d h}{d x} \approx \frac{{Δ}_{x} h}{Δ x} = \frac{h ( {x}_{2} ) - h ( {x}_{1} )}{Δ x} \qquad ( 7 )$$

The FIG. 2 shows readings from the first sensor as rime function in the case of object motion with constant velocity vₓ. During time Δt=t₂−t₁ the object passes the distance that proportional to motion velocity:

Δₜx=vₓΔt. (8)

From the first sensor readings we can calculate a height change caused by the object motion:

Δₜh=(t₂)−(h₁(t₁). (9)

This value can be also expressed as:

$${Δ}_{t} h = \frac{{Δ}_{x} h}{Δ x} \cdot {Δ}_{t} x \qquad ( 10 )$$

Substituting (8) into (10), we have:

$$\begin{matrix}{Δ}_{t} h = \frac{{Δ}_{x} h}{Δ x} \cdot Δ t \cdot {v}_{x} \\ or & ( 11 ) \\ \begin{matrix}{v}_{x} = \frac{{Δ}_{t} h}{{Δ}_{x} h} \cdot \frac{Δ x}{Δ t} \\ = \frac{{h}_{1} ( {t}_{2} ) - {h}_{1} ( {t}_{1} )}{{h}_{2} ( {t}_{1} ) - {h}_{1} ( {t}_{1} )} \cdot \frac{Δ x}{Δ t} \\ = \frac{h ( {x}_{1} , {t}_{2} ) - h ( {x}_{1} , {t}_{1} )}{h ( {x}_{2} , {t}_{1} ) - h ( {x}_{1} , {t}_{1} )} \cdot \frac{Δ x}{Δ t}\end{matrix} & ( 12 )\end{matrix}$$

The equation (12) shows that according to theoretical consideration of the one dimension case, the velocity can be calculated from three readings. Two readings are received from the first sensor at two different times (h(x₁,t₁) and h(x₁,t₂)) and one from the second sensor (h(x₂,t₁)).

Practically DMMD method requires a large number of measurements for the following reasons. The real profile is not so smooth and signal derivative estimation is not sufficiently exact. The real signal is noisy, strongly affecting signal derivative estimation.

The practical DMMD is implemented over a set of signals which can be obtained by means of Spatial Domain or Time Domain modes. The x and y velocity are obtained from set of signals using the Two-dimension Linear Regression and the Least Square method (LSM).

We suppose that we have four associate sets of signals:

Iₖ(x,y,t),

Iₖ(x,y,t+Δt),

Iₖ(x+Δx,y,t)

Iₖ(x,y+Δy,t), (13)

where k=1÷K.

We introduce the following designations:

$$\{ \begin{matrix}{F}_{k} = \frac{{I}_{k} ( x , y , t + Δ t ) - {I}_{k} ( x , y , t )}{Δ x} \\ {X}_{k} = \frac{{I}_{k} ( x + Δ x , y , t ) - {I}_{k} ( x , y , t )}{Δ x} \\ {Y}_{k} = \frac{{I}_{k} ( x , y + Δ y , t ) - {I}_{k} ( x , y , t )}{Δ y} .\end{matrix} \qquad ( 14 )$$

Substituting (14) into (6), we have:

Fₖ=Xₖ·vₓ+Yₖ·V_{y}. (15)

The equation (15) is the 2D linear regression equation with unknown variables vₓ and v_{y} and experimentally obtained statistical data Fₖ, Xₖ and Yₖ. Least Square method (optimal variables v*ₓ and v*_{y}) is used for determination of unknown x and y velocities. Expressing the average error function as:

$$G ( {v}_{x} , {v}_{y} ) = \frac{1}{K} \cdot {\sum }_{k = 1}^{K} {( {F}_{k} - {X}_{k} \cdot {v}_{x} - {Y}_{k} \cdot {v}_{y} )}^{2} \qquad ( 16 )$$

We find unknown optimal variables v*ₓ and v*_{y} characterized minimal average error.

The necessary conditions of minimum are given by:

$$\{ \begin{matrix}\frac{\partial G ( {v}_{x} , {v}_{y} )}{\partial {v}_{x}} = - \frac{2}{K} \cdot {\sum }_{k = 1}^{K} ( {F}_{k} - {X}_{k} \cdot {v}_{x} - {Y}_{k} \cdot {v}_{y} ) {X}_{k} = 0 \\ \frac{\partial G ( {v}_{x} , {v}_{y} )}{\partial {v}_{y}} = - \frac{2}{K} \cdot {\sum }_{k = 1}^{K} ( {F}_{k} - {X}_{k} \cdot {v}_{x} - {Y}_{k} \cdot {v}_{y} ) {Y}_{k} = 0\end{matrix} \qquad ( 17 )$$

We introduce the following designations:

$$\{ \begin{matrix}{S}_{FX} = {\sum }_{k = 1}^{K} {F}_{k} {X}_{k} \\ {S}_{FY} = {\sum }_{k = 1}^{K} {F}_{k} {Y}_{k} \\ {S}_{XX} = {\sum }_{k = 1}^{K} {X}_{k}^{2} \\ {S}_{YY} = {\sum }_{k = 1}^{K} {Y}_{k}^{2} \\ {S}_{XY} = {\sum }_{k = 1}^{K} {X}_{k} {Y}_{k} \\ {S}_{FF} = {\sum }_{k = 1}^{K} {F}_{k}^{2}\end{matrix} \qquad ( 18 )$$

After substitution (18) into (17), we have the system of two linear equations:

$$\{ \begin{matrix}{v}_{x}^{*} \cdot {S}_{XX} + {v}_{y}^{*} \cdot {S}_{XY} = {S}_{FX} \\ {v}_{x}^{*} \cdot {S}_{XY} + {v}_{y}^{*} \cdot {S}_{YY} = {S}_{FY}\end{matrix} \qquad ( 19 )$$

Solving the obtained equation system (19) for example by means of the Cramer rule we have:

$$\{ \begin{matrix}{v}_{x}^{*} = \frac{{S}_{FX} {S}_{YY} - {S}_{FY} {S}_{XY}}{{S}_{XX} {S}_{YY} - {S}_{XY}^{2}} \\ {v}_{y}^{*} = \frac{{S}_{FY} {S}_{XX} - {S}_{FX} {S}_{XY}}{{S}_{XX} {S}_{YY} - {S}_{XY}^{2}}\end{matrix} \qquad ( 20 )$$

Spatial Domain and Time Domain data processing algorithms contain the following steps:
(a) 3 sets of derivatives Fₖ, Xₖ and Yₖ using (14);
(b) 6 sums S_{FX}, S_{FY}, S_{XX}, S_{YY}, S_{FF} and S_{XY} using (18);
(c) Calculating velocities v*ₓ and v*_{y} using (20).

### Spatial Domain Implementation

The Spatial Domain mode is implemented by a standard image sensor of M×N pixels size. For each velocity calculation data sets corresponding to two consecutive time frames:

I(xₘ,yₙ,t)

I(xₘ,yₙ,t+Δt) (21)

where m=1÷M and n=1÷N.

Expressing the received data (21) in a general form (see (13)) we have:

Iₖ(x,y,t)=I(xₘ,yₙ,t),

Iₖ(x,y,t+Δt)=I(xₘ,yₙ,t+Δt),

Iₖ(x+Δx,y,t)=I(xₘ₊₁,yₙ,t)

Iₖ(x,y+Δy,t)=I(xₘ,yₙ₊₁,t), (22)

where k=1÷(M−1)×(N−1).

The received four data sets (22) should be substituted in general algorithm as data sets (21).

### Time Domain Implementation

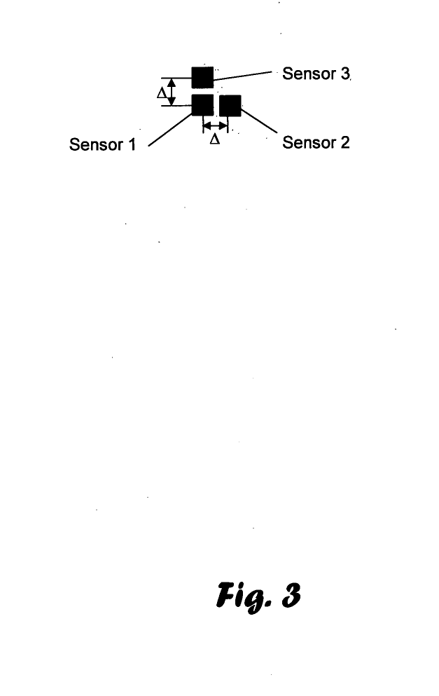

Reference is now made to FIG. 3, presenting a minimal sensor configuration which is sufficient for Time Domain mode implementation.

For each calculation of the object velocity a required data set is build from K consequential signals:

I₁(t−kΔt)

I₂(t−kΔt)

I₃(t−kΔt) (23)

where k=0÷K−1

Expressing the received data (23) in general form, we have (see (13)):

Iₖ(x,y,t)=I₁(t−kΔt)

Iₖ(x,y,t+Δt)=I₁(t−(k−1)Δt)

Iₖ(x+Δx,y,t)=I₂(t−kΔt)

Iₖ(x,y+Δy,t)=I₃(t−kΔt) (24).

where k=1÷K−1

The received four data sets (24) should be substituted into general algorithm as data sets (13).

It should be emphasized that proposed differential method does not use image (pattern, block, row, or other fixed form of objects) analysis. A set of discretized individual sensors is used to detect object motion and calculate parameters thereof. The standard image processing (analysis) is concentrated at a specifically defined shape/body in the process of analysis. The proposed device cannot be used a biometric device and not designed for personal identification.

The statistical processing of obtained results can be performed by means of Linear Regression, Kalman Filter, and others.

In accordance with the current invention, the input device is finger operated. Motion of the fingerprint pattern (ridges) is detected by at least three spaced apart sensors (microelectomechanical system, a strain gauge, an optical displacement sensor, an optical reflective sensor, a capacitive sensor, and any combination thereof) at a distance smaller than the distance between user's finger ridges.

Sensor is adapted to provide the analyzing unit with signals corresponding to the user's fingerprint ridges, signals that alter as the user's finger move across the sensor's pixel/member/ridge.

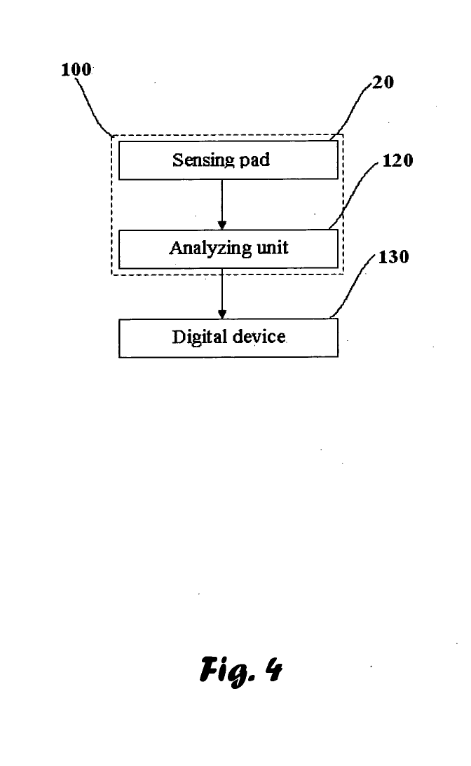

Reference is now made to FIG. 4, presenting a schematic view of the finger-operated input device is connectable to a digital device. The input device comprises a sensing pad responsive to displacement of the user finger. The finger displacement is substantially parallel to the pad 20 within its proximity. The sensing pad 20 is arranged for transmitting electrical signals in response the finger displacement. The electrical signals are received by an analyzing unit 120. Then, data defining trajectory of the finger is calculated. The obtained trajectory data are transmitted to the digital device 130. The sensing pad comprises at least three sensors (as shown in FIG. 3) perceptive to motion of finger ridges relative to the sensors. The distance between the sensors is smaller than a distance between any two adjacent ridges of user's finger. The distance between the sensors is less than about 0.5 mm and preferably less 0.1 mm.

The pad is arranged to be perceptively different from environment, and difference in perception is selected from the group consisting of color, material, texture, temperature of the sensing pad relative to the environment and any combination thereof.

The analyzing unit is arranged to receive and differentially analyze a consequence of the timely framed signals in a cyclic manner.

A method of inputting commands by a user's finger into a digital device is disclosed. The inputting method is implemented as follows. The finger-operated navigating device I is provided. The user displaces his/her finger in parallel to the sensing pad. The finger displacement is detected by the sensors. The electrical signals generated by the sensors are cyclically picked up by the analyzing unit. The obtained signals are differentially analyzed. The trajectory of the user's finger is calculated. The commands corresponding to calculated trajectory are transmitted to the digital device.

It should be emphasized that detection of the finger displacement is performed by at least three spaced apart sensors which are embedded into a sensing pad. The sensors are perceptive to motion of finger ridges relative to the sensors.

In accordance with one embodiment of the current invention the step cyclically picking up the electrical signals is performed in a time domain mode. The picking frequency is higher than 120 frames per second.

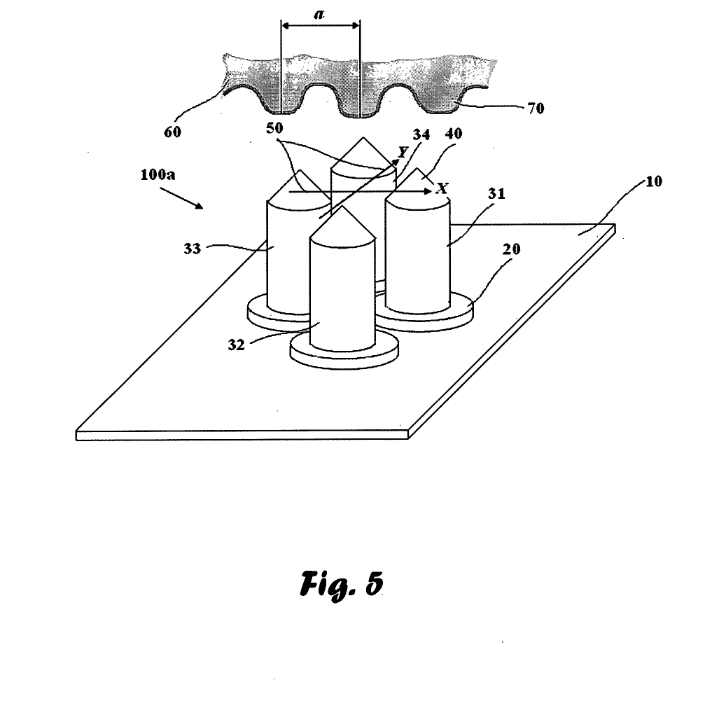

Reference is now made to FIG. 5, showing a conceptual view of a finger-operated input device 100a. The device 100a comprises a support structure 10, projecting members 31, 32, 33, and 34 having extremities 40. Each projecting member is furnished with a force sensor 20. Axes 50, namely, axis X and axis Y, are introduced for describing user's finger moving relative to the projecting members 31-34. As seen in FIG. 1, the user's finger 60 having at its skin ridges 70 moves in parallel to a plane defined by the axes 50 and contacts the extremities of the projecting means. Forces longitudinally applied to the projecting members 30-34 are defined by the finger skin relief. A period of ridge structure is a. A cross sectional dimension of extremities 40 is less than a. Moving the skin ridges through the extremities 40 induces variation in the signals transmitted by the force sensors 20 individually attached to the individual projecting members 31-34. It should be emphasized that the extremity dimension less than a provides sufficient spatial resolution for detecting the user's finger skin relief.

It is further acknowledged herein that any type of sensor may be used for detecting the finger ridges, such as pressure sensors carrying protruding rods, air pressure sensors receiving impulses via holes in the panel or platform, miniature capacitive sensors that measure capacitance to the finger, elastic, electrically conductive elastomeric elements or a combination thereof. The person skilled in the art will, based on the current disclosure, be able to envisage many other types of sensors, all of which fall within the scope of the disclosure of this invention.

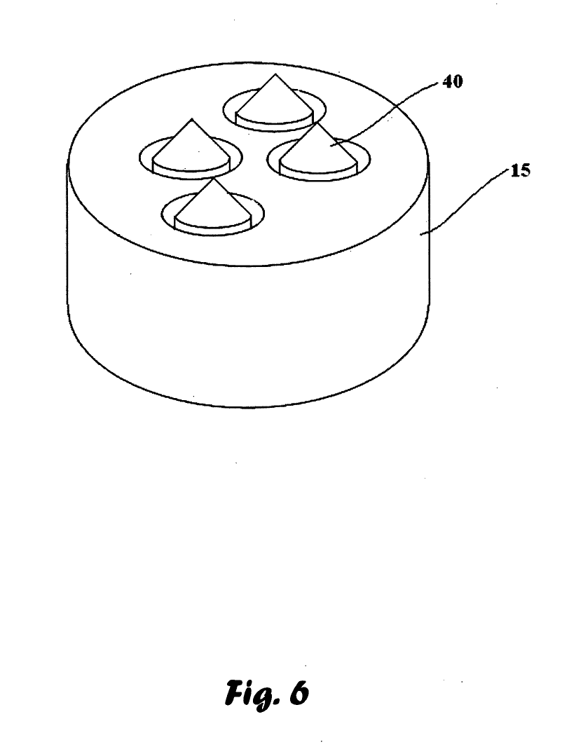

Reference is now made to FIG. 6, presenting a schematic view of the input device accommodated in a housing 15. As seen in FIG. 6, the extremities 40 project from the housing 15 and are available for applying the force by the user's finger. The proposed technical solution enables the implementer to miniaturize in greater degree the developed digital devices. The dimensions of the input device are defined by the projecting member, while the user's finger moves outside the input device.

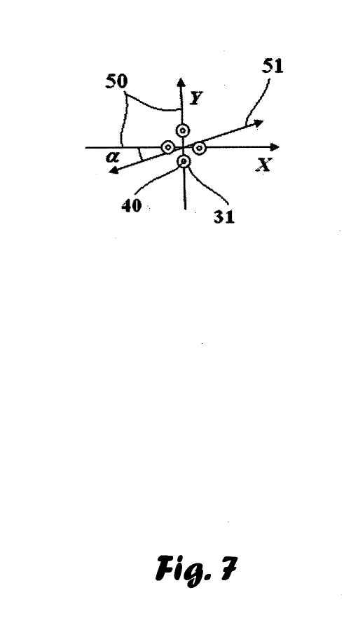

Reference is now made to FIG. 7, presenting one of possible directions of the finger moving. The user's finger moves along a direction 51 in the axes 50. As said above, the sensors 20 (not shown) transmit the corresponding signals to the analyzing unit (not shown).

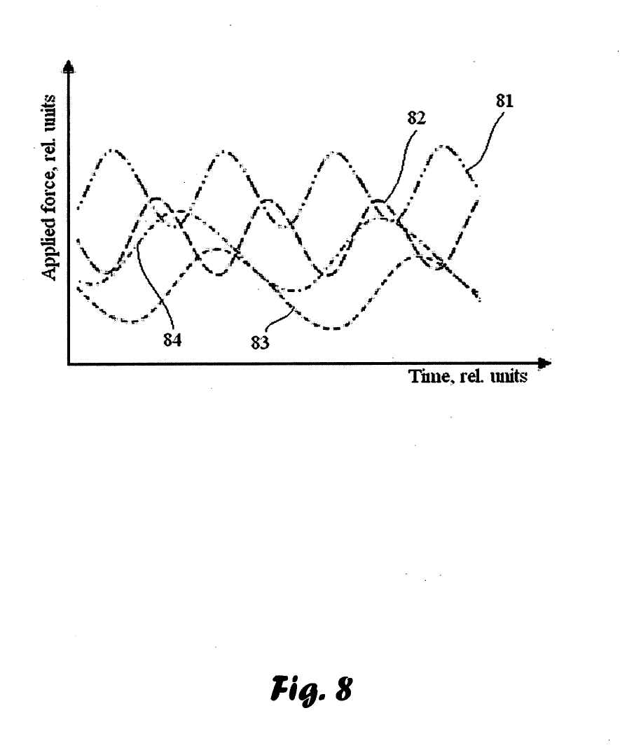

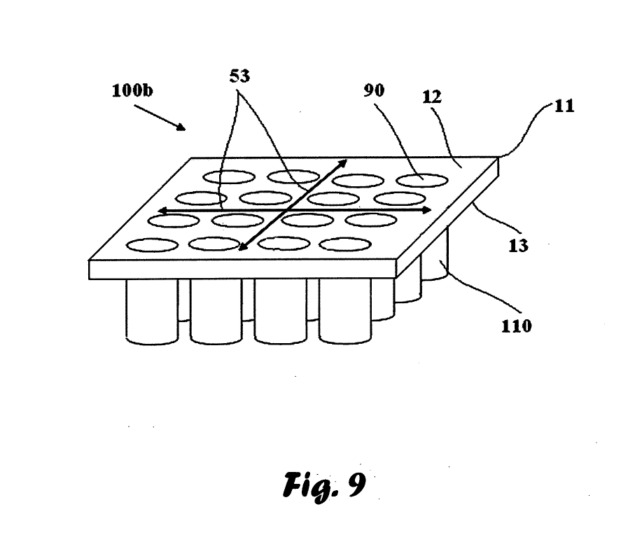

Reference is now made to FIG. 8, showing theoretical temporal dependences 81, 82, 83, and 84 of signal value transmitted by the sensors 20 attached to the projecting members 31, 33, 32, and 34, respectively. The finger ridges 70 (not shown) are parallel to the axis Y. As seen in FIG. 7, the movement direction 51 is at an acute angle α. The curves 81/82 and 83/84 are characterized by equal periods of curves of each pair. The aforesaid curves 81/82 and 83/84 are phase shifted relative to each other. Calculating curve periods and phase sift enable the analyzing unit to recognize the input data. The detected curves 81-84 may used for calculating the finger's movement by means correlation analysis of 6 possible combinations of the aforesaid curves for increasing calculation accuracy. The waveforms in FIG. 9 are shown as an illustration. It should be emphasized that the waveforms received from the sensors are of arbitrary forms. The information is extracted by calculating the time-shift between detected signals to reach maximum correlation. This time shift correlation is calculated in real-time between all possible pairs of sensors. The speed of the finger's movement is calculated by dividing the inter-sensor distance over the signal time shift for two sensors of the best signal correlation.

Reference is now made to FIG. 9, showing a finger-operated input device 100b. The device 100b comprises a plate-like supporting structure 11 having two sides 12 and 13, a matrix of openings 90, and pneumatic sensors singly attached to the openings from the side 13. Arrays 53 indicate preferable directions of the user's finger path. Stroking the user's finger along the support structure 11 induces pneumatic impulses detectable by the pneumatic sensors 110. Analogously to the above, the aforesaid sensors 110 transmit signals corresponding to the pneumatic impulses to the analyzing unit 120 (not shown). The analyzing unit 120 is preprogrammed to recognize the input data and further transmit it to the digital device 130 (not shown).

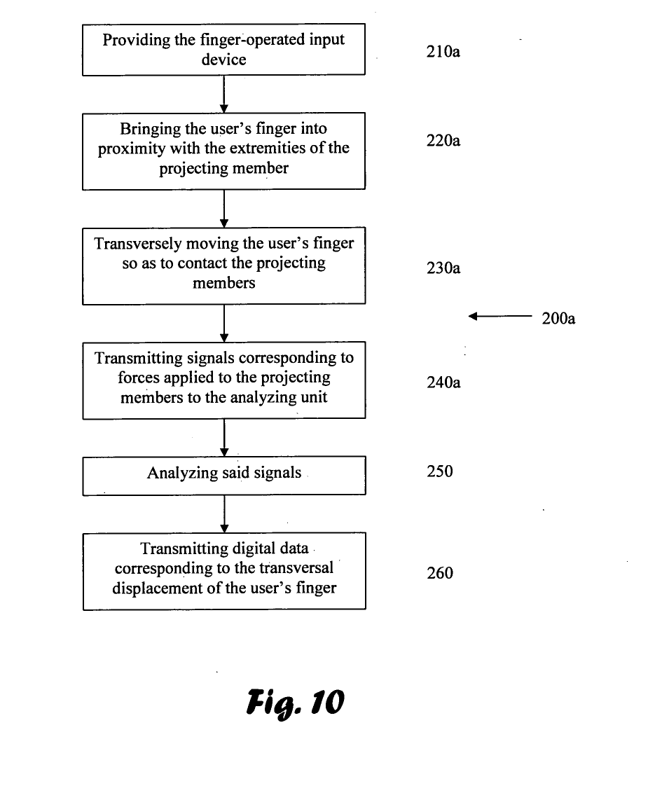

Reference is now made to FIG. 10, presenting a method 200a of using the finger-operated input device based on varying a force applied to the projecting members of the aforesaid device according the relief of the user's finger skin. The input device is provided at the step 210a. For controlling/displacing a pointer on the display of the digital device (as defined above), the user brings his/her finger into proximity with the extremities of the projecting members (step 220a) and displaces the aforesaid finger relative to the projecting members (step 230a). The force applied to the extremities of the projecting members is varied according to the user's finger skin relief modulated by the skin ridges. The force sensors singly attached to the projecting members transmit signals corresponding to forces longitudinally applied to the aforesaid projecting members at the step 240a.

Further, the sensor signals are analyzed in the analyzing unit (step 250) in order to calculate real displacements of the user's finger and recognize data input by the user. The recognized data are transmitted to the digital device at the step 260.

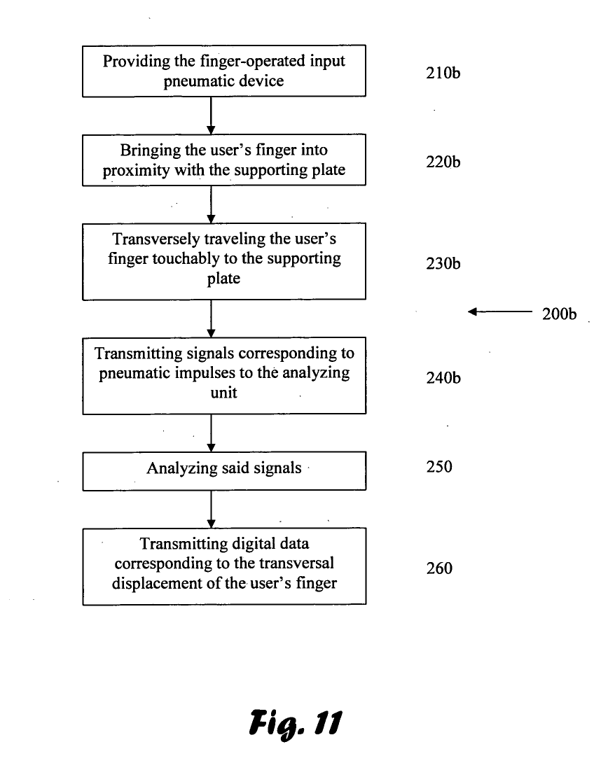

Reference is now made to FIG. 11, presenting a method 200b of using the finger-operated input device based on detecting a pneumatic impulse creating by the user's finger that strokes the supporting plate. The input device is provided at the step 210b. For controlling/displacing a pointer on the display of the digital device (as defined above), the user brings his/her finger into proximity with the supporting plate (step 220b) and displaces the aforesaid finger along the aforesaid supporting plate (step 230b). The pneumatic impulses detected by the pneumatic sensors are transmitted to the analyzing unit at the step 240b.

Further, analogously to the method 200a, the sensor signals are analyzed in the analyzing unit (step 250) in order to calculate real displacements of the user's finger and recognize data input by the user. The recognized data are transmitted to the digital device at the step 260.

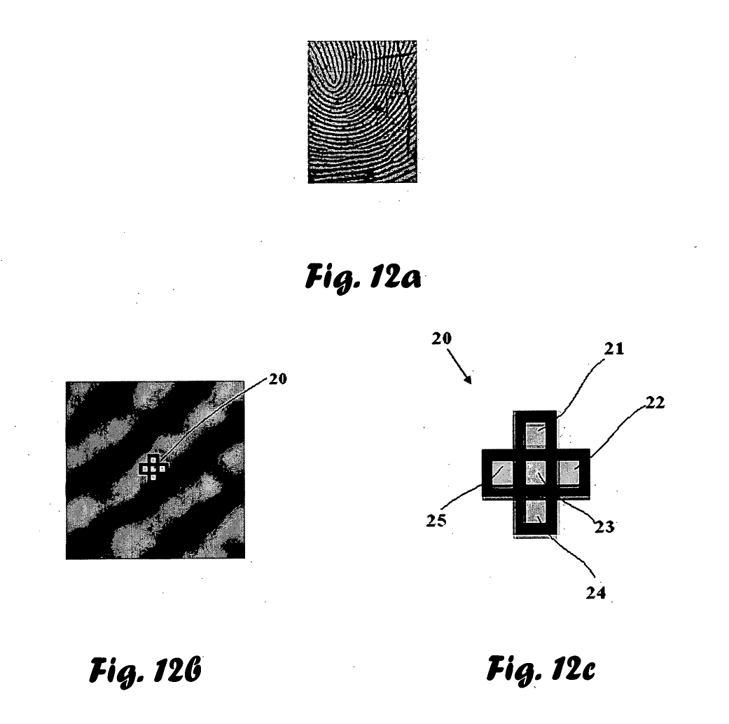

Reference is now made FIGS. 12a to 12c, illustrate the procedure of obtaining the primary data. Specifically, FIG. 12a is a photograph exemplary of finger ridges (finger print). In accordance with proposed approach, ridges height profile is generated.

FIGS. 12b and 12c, present a sensor arrangement (sensing pad) 20. The sensing pad is adapted to generate electrical signals corresponding to the relief of moving finger. FIG. 12b illustrates size proportion between the finger ridges and the sensors. FIG. 12c specifies the arrangement of sensors 21-25. Two finger motion trajectories were simulated, specifically, horizontal and vertical linear motions with 10 mm/s constant speed.

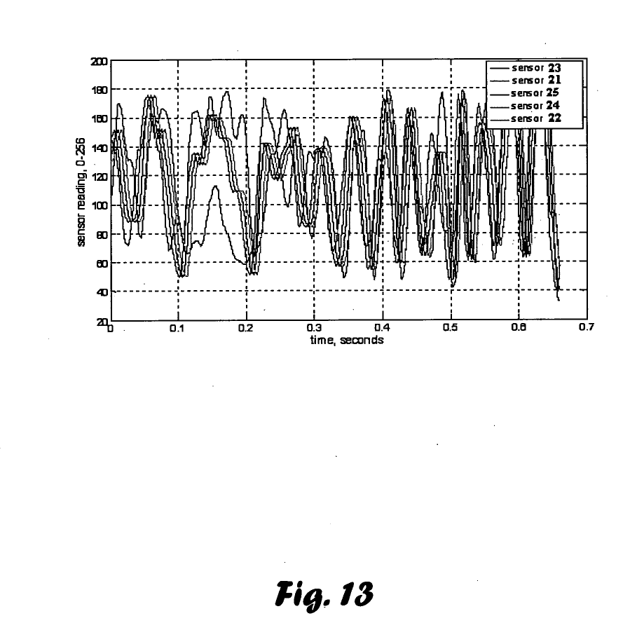

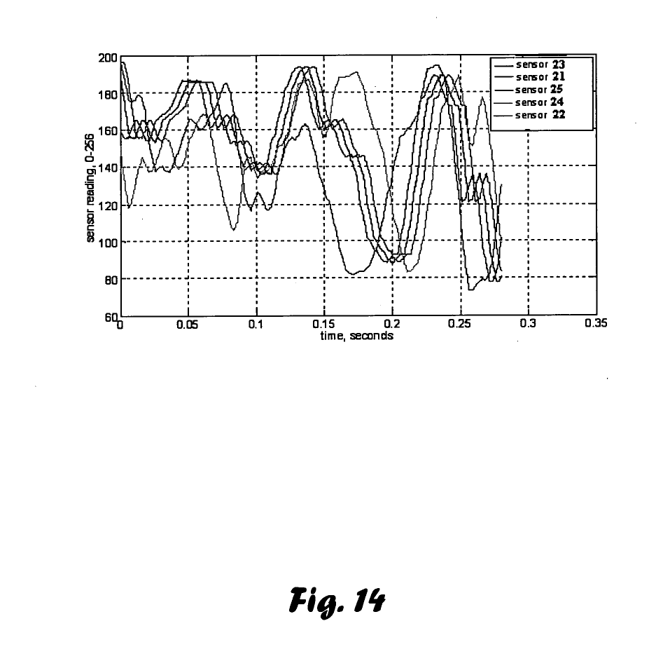

Reference is now made to FIGS. 13 and 14, presenting simulated sensor readings corresponding to the user's finger in X and Y directions, respectively. The obtained curves show finger relief height (ridges) detected by the sensors 21-25 during the finger motion.

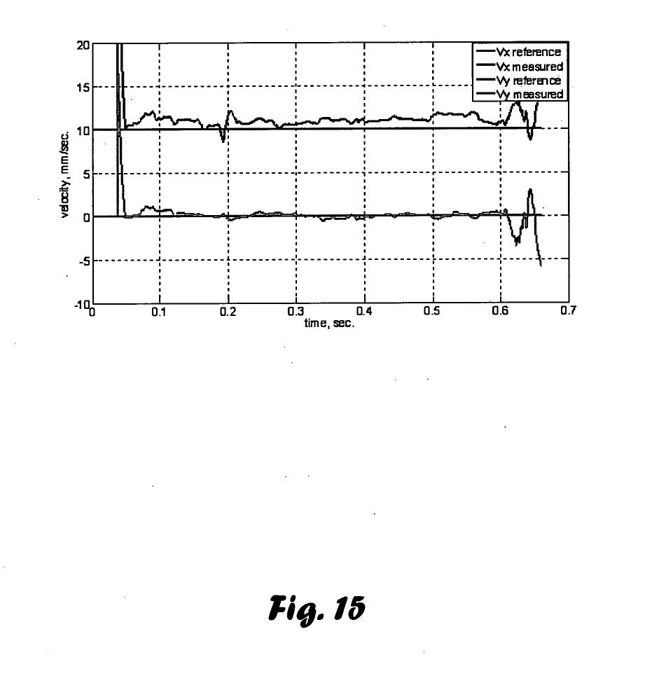

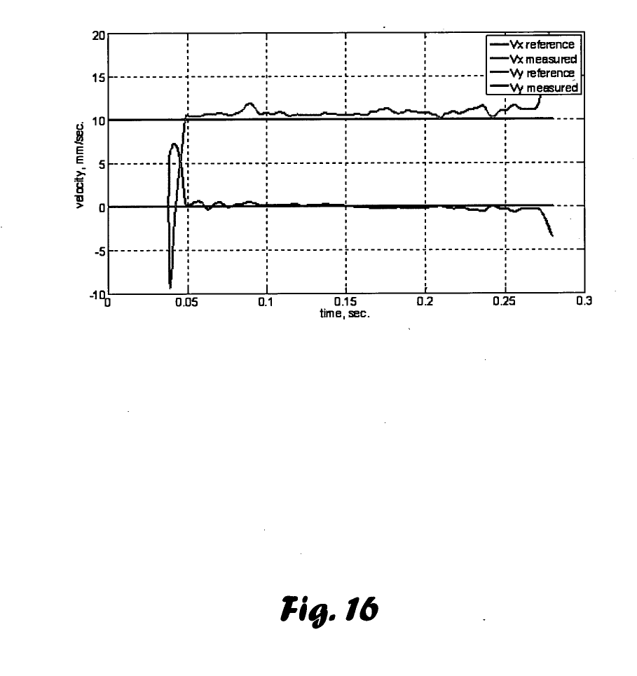

Reference is now made to FIGS. 15 and 16, presenting graphs of simulated velocity profile for motion in X and Y direction, respectively. Reference curves constitute ideally processed data. FIGS. 15 and 16 show imprecision of about ±5% that proves operability of the current invention. In FIG. 15 we can see constant 10 mm/s velocity in the X direction and zero-velocity in the Y direction. In FIG. 16 we can see zero-velocity in the X direction and constant 10 mm/s velocity in the Y direction.

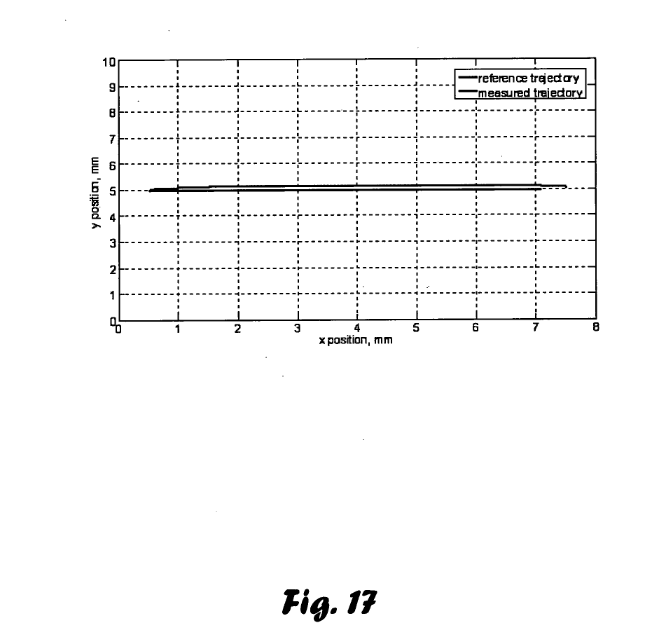

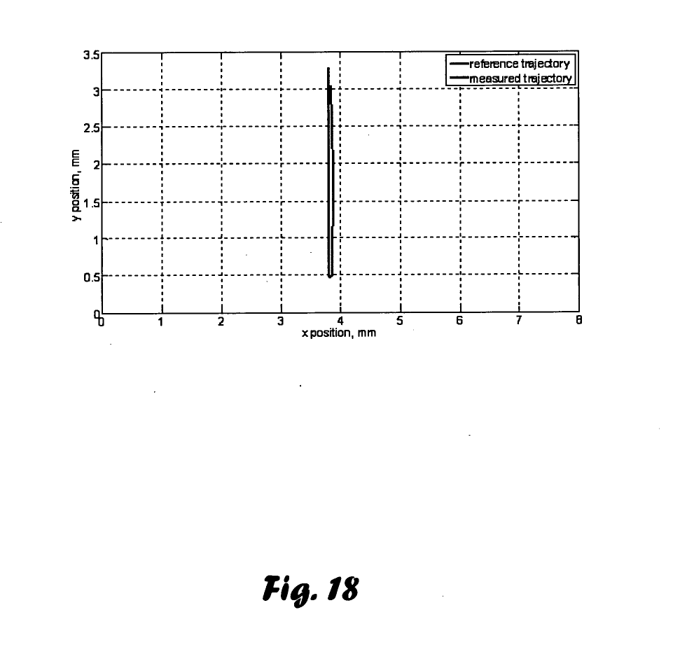

Reference is now made to FIGS. 17 and 18, presenting graphs of simulated trajectory profiles for motion in X and Y direction, respectively. It is should be emphasized that simulated trajectories precisely correspond to the primary data, specifically; horizontal and vertical linear motions with 10 mm/s constant speed.

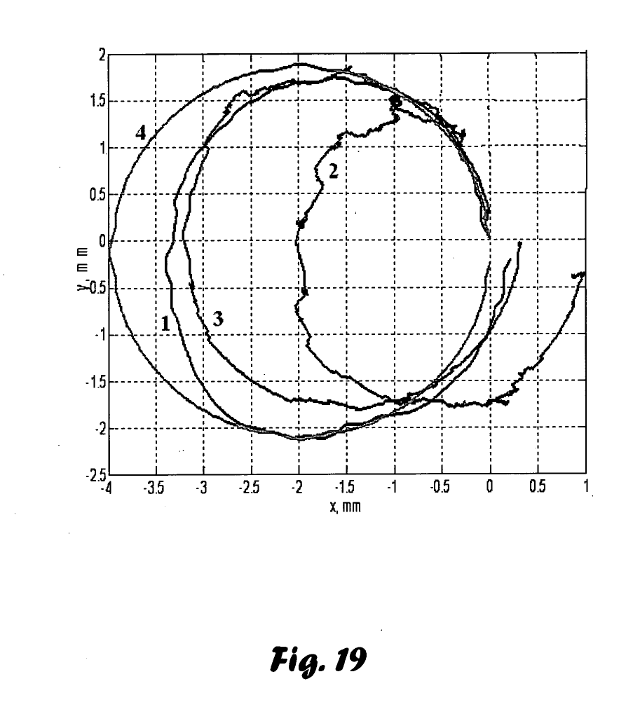

Reference is now made to FIG. 19, presenting comparison of the differential and reference algorithms which were tested using simulated sensor signals set for circular finger motion. The simulated trajectory was of 4 mm diameter. Time period of motion was 1 sec. The frame rate of 1000 fps was used in all simulations. The reference algorithm constitutes the known in the art correlation analysis of two consecutive image frames divided by the time period 20 msec.

Curves 1 and 2-4 correspond to trajectories calculated by means of differential and reference algorithms, respectively. Specifically, the curve 1 is calculated for the sensor array of 7×7 sensors, the curve 2 for the array of 9×9 sensors, the curve 3 for the array of 10×10 sensors and the curve 4 for the array of 14×14 sensors.

The comparative analysis indicates that differentially processed data from sensor array of 7×7 sensors provide a trajectory comparable in terms of precision with the array of 10×10 sensors. It was demonstrated that the proposed technical solution allows the input device to be more miniature in comparison with known input device. Additionally, the proposed method needs minor computational resources in comparison with the method of correlation image analysis.

1-42. (canceled)

43. The finger-operated input device connectable to a digital device, said input device comprising
a. a sensing pad being responsive to displacement of said finger substantially parallel to said pad in a reach range thereof and transmitting electrical signals in response thereto;
b. an analyzing unit arranged to receive said electrical signals and calculate data defining trajectory of said finger and transmit said data to said digital device;
wherein said sensing pad comprises at least three sensors perceptive to motion of finger relative to said sensors.

44. The finger-operated input device according to claim 43, wherein a distance between said sensors is smaller than a distance between any two adjacent ridges of user's finger; said distance between said sensors is less than about 0.5 mm and preferably less 0.1 mm.

45. The finger-operated input device according to claim 43, wherein said pad is arranged to be perceptively different from environment.

46. The finger-operated input device according to claim 43, wherein said analyzing unit is arranged to receive and differentially analyze a consequence of said time framed signals in a cyclic manner.

47. A finger-operated input device for controlling a digital device comprising:
a. a support structure;
b. at least three projecting members having first and second terminals; said members are mechanically secured substantially adjacent to each other, at a substantially normal orientation to said support structure by means of said first terminals;
c. force sensors, at least one force sensor attached to each said projecting member; and
d. an analyzing unit;
wherein each said sensor is adapted to provide said analyzing unit with signals corresponding to forces longitudinally applied to said projecting members by said user's finger moving substantially transversely to said projecting members and contacting said second terminal portions thereof; said analyzing unit is adapted for calculating said user's finger transversal moving and transmitting calculation results to said digital device.

48. The finger-operated input device according to claim 47, wherein cross sectional dimension of an extremity of said second terminal portion of each projecting member in the order of the distance between any two adjacent ridges of user's finger; said cross sectional dimension of said second extremity is in a range of about 0.1 to about 2.0 mm, preferably in a range of about 0.2 to about 0.5 mm.

49. The finger-operated input device according to claim 48, wherein said input device is adapted to be activated in response to said sensor signal larger than a predetermined value.

50. The finger-operated input device according to claim 47, wherein said analyzing unit is adapted for changeably scaling data transmitted to said digital device.

51. The finger-operated input device according to claim 47, wherein at least one said projecting member is provided with a thermal sensor adapted to activate said input device in response to contacting said projecting member to an object of a temperature substantially higher than ambient temperature equal to a temperature of the user's finger for preventing false activation.

52. The finger-operated input device according to claim 47, wherein said input device further comprises a band filter having a bandpass substantially equal to a bandpass of said signal corresponding to said finger moving; said filter is adapted to filter strays off said signal transmitted by said force sensors to said analyzing unit.

53. The finger-operated input device according to claim 47, wherein said force sensors are chosen from the group consisting of a microelectomechanical system, a strain gauge, a optical displacement sensor, a magnetic proximity sensor, a capacitive sensor, and any combination thereof.

54. A finger-operated input device for controlling a digital device comprising:
a. a support structure;
b. at least three projecting members having first and second terminal; said members are mechanically secured substantially adjacent to each other, at a substantially normal orientation to said support structure by means of said first terminal;
c. capacitive sensors, at least one force sensor attached to each said projecting member; said capacitive sensors are adapted for measuring a distance to finger skin; and
d. an analyzing unit;
wherein each said sensor is adapted to provide said analyzing unit with signals corresponding to forces longitudinally applied to said projecting members by said user's finger movement substantially transversely to said projecting members; said analyzing unit is adapted for calculating said user's finger transversal moving and transmitting calculation results to said digital device.

55. A finger-operated input for controlling a digital device comprising:
a. a support plate-like structure having first and second sides and a regularly disposed matrix of passages between said sides;
b. a plurality of sensors individually mechanically secured to said passages from said first side; and
c. an analyzing unit;
wherein each said sensor is adapted to transmit to said analyzing unit with a signal corresponding to an impulse provided by user's finger moving substantially transversely and contacting said second side; said analyzing unit is adapted for calculating said user's finger transversal moving and transmitting calculation results to said digital device.

56. The finger-operated input device according to claim 55, wherein said sensors are chosen from the group of sensors providing electrical signals in response to pneumatic, elastic, optical and capacitive effects.

57. The finger-operated input device according to claim 55, wherein said sensor is adapted to detect finger surface features, chosen from the group consisting of a microelectomechanical system, a strain gauge, an optical displacement sensor, an optical reflective sensor, a capacitive sensor, and any combination thereof.

58. The finger-operated input device according to claim 55, wherein said analyzing unit is adapted to be activated in response to said sensor signal larger than a predetermined value.

59. The finger-operated input device according to claim 55, wherein said analyzing unit is adapted for changeably scaling data transmitted to said digital device.

60. The finger-operated input device according to claim 55, wherein said support structure is provided with a thermal sensor adapted to activate said input device in response to contacting an object of a temperature substantially equal to a temperature of said user's finger to said support structure for preventing false activation.

61. The finger-operated input device according to claim 55, wherein said input device further comprises a band filter having a bandpass substantially equal to a bandpass of said signal corresponding to said finger moving; said filter is adapted to filter strays off said signal transmitted by said force sensors to said analyzing unit.

62. The finger-operated input device according to claim 55, wherein said analyzing unit is adapted to recognize at least two levels of user's control action; said levels comprise a regular level and at least one level higher in comparison with said regular level; said control action of said higher level is adapted for providing an independent input data channel.
